(19) United States
(12) Patent Application Publication
(10) Pub. No.: US 2012/0043436 A1
(43) Pub. Date: Feb. 23, 2012

(54) HEIGHT-ADJUSTABLE FURNITURE

(75) Inventor: Stephen Atkinson, Lancashire (GB)

(73) Assignee: G.J.M.S. HOLDINGS LIMITED, Lancashire (GB)

(21) Appl. No.: 13/266,780

(22) PCT Filed: Mar. 24, 2010
(86) PCT No.: PCT/GB2010/050493

§ 371 Date: Oct. 28, 2011

(30) Foreign Application Priority Data
Apr. 28, 2009 (GB) 0907264.6

(51) Int. Cl. F16M 11/26

(52) U.S. Cl. 248/188.5

(57) ABSTRACT

Disclosed is a height adjustable leg for use with furniture, comprising: first and second tubular sections arranged to telescopically couple; an actuator arranged internally to the first and second sections to maintain a selected height; a bearing arranged between the first and second sections to allow smooth relative movement there between and to accommodate manufacturing tolerances.

The present invention is concerned with height adjustable furniture. In particular, but not exclusively, it concerns a means by which a range of different heights can be achieved using a single type of height adjustable leg.

There is a requirement for height adjustable furniture in a variety of different situations. One of the main applications for such furniture is in schools and other educational establishments. The furniture which is routinely used in schools can be used by a wide range of different age groups and in a wide range of different settings. For instance, a table to be used by a group of younger children for seated lessons obviously has different requirements to a work bench to be used by a group of older children in a laboratory setting where they will generally be standing up or seated at a high stool. In order to maintain as much flexibility as possible, many schools wish to have furniture which can be adapted to a variety of different needs without purchasing a range of different types of furniture.

In fact, there is a new European Standard (EN1729), which requires that table and workbench heights in schools are adjusted to the height of the children using them. In a typical school environment, there is a wide variation of possible heights which must be complied with to conform to the standard.

Furthermore, the provision of height adjustable legs to furniture can result in problems with instability, particularly if a very wide range of heights is to be accommodated by said adjustable legs.

It is an aim of embodiments of the present invention to address shortcomings and problems with the prior art whether mentioned explicitly herein or not.

According to the present invention there is provided an apparatus and method as set forth in the appended claims. Other features of the invention will be apparent from the dependent claims, and the description which follows.

For a better understanding of the invention, and to show how embodiments of the same may be carried into effect, reference will now be made, by way of example, to the accompanying diagrammatic drawings in which:

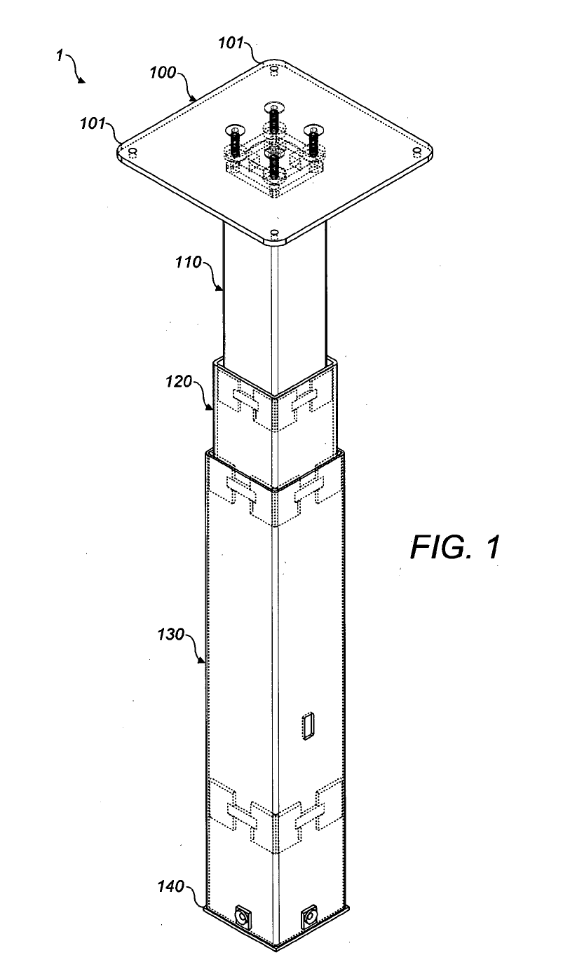

FIG. 1 shows a first embodiment of the present invention, comprising a three-section height adjustable leg for furniture;

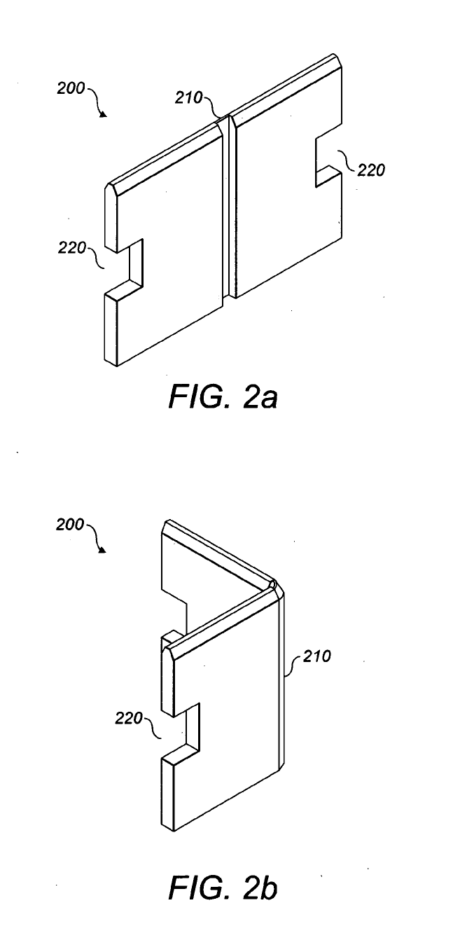

FIG. 2a and FIG. 2b show different views of a bearing for use with the height adjustable leg of FIG. 1;

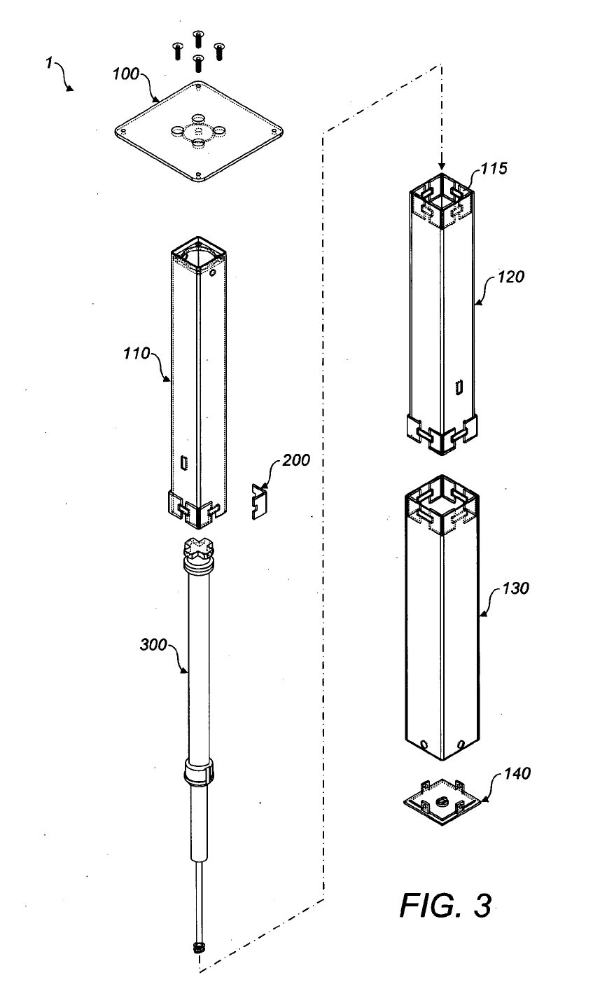

FIG. 3 shows an exploded view of the height adjustable leg of FIG. 1;

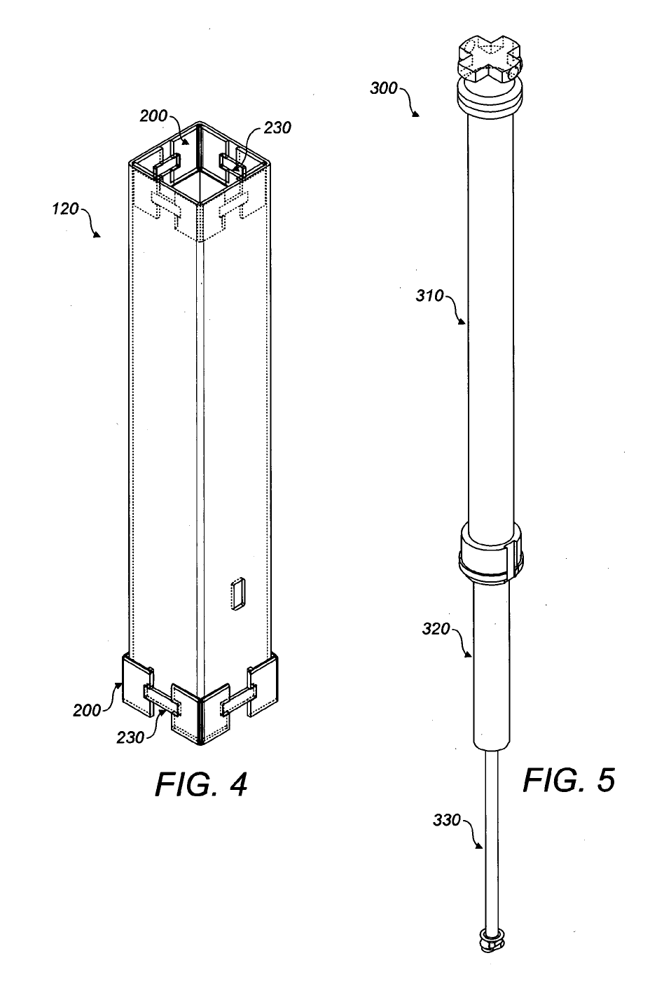

FIG. 4 shows a more detailed view of the central section of the height adjustable leg of FIG. 1; and

FIG. 5 shows a more detailed view of a triple screw actuator forming part of the height adjustable leg of FIG. 1.

FIG. 1 shows a height adjustable leg, suitable for use with a wide range of furniture. Typical applications will include desks and work benches for use in a school environment. Other uses are envisaged and can include laboratories, office environments, workshops, adjustable stands for supporting flat screen TV and computer monitor screens and anywhere else where user configurable tables and/or surfaces are required.

The leg 1 comprises three telescopic sections 110, 120 and 130. The upper part of the leg is terminated in a fixing plate 100 which is arranged to be screwed or otherwise fastened to the underside of the work surface. A plurality of screw holes 101 are provided for this purpose.

Attached to the fixing plate 100 is the inner telescopic section 110 which descends downwardly from the fixing plate, in use. The inner telescopic section 110 is arranged to fit snugly within the central telescopic section 120, which in turn is arranged to fit snugly within the outer telescopic section 130. The outer telescopic section 130 is terminated in a foot plate 140 which, in use, is arranged to rest on the floor.

The three sections 110, 120, 130 are arranged in a telescopic fashion such that the height of the work surface can be varied as required. The height is maintained by use of a triple screw actuator 300 which will be described in more detail shortly.

Each of the three telescopic sections 110, 120, 130 is manufactured from tubular steel which, in turn, is formed from sheet steel which is formed into a tube having a given nominal cross section. The internal and external diameters of the tube can vary significantly. It is found in practice that the actual thickness of the tubular steel itself can vary by up to +/−10% and also the internal/external diameter can change significantly between different batches, although it is generally consistent on a given batch.

Alternatively, the tubular sections can be manufactured from other materials, such as aluminium or plastics materials. The same considerations apply to these other materials also.

These inconsistencies in steel thickness and internal/external diameter mean that creating a stable and snug fit between adjacent sections of the tubes is difficult, if not impossible. If the tolerances are such that a larger than intended gap is left between adjacent sections then an intolerable degree of rattling and instability can be induced into the table leg. On the other hand, if the tolerances are such that one section will not actually fit inside the adjacent section, then the leg cannot be assembled properly.

Although the embodiment shown and described in FIG. 1 and the following figures shows three tubular sections, each having a generally square cross section, the same problems can arise for any given shape, e.g. rectangular or circular cross sections. The principles involved in different embodiments of the invention are, however, the same.

In order to provide a guaranteed reliable fit between adjacent sections of tubing, embodiments of the invention make use of a bearing 200 which is fitted at the interface between adjacent sections of tubing. FIG. 2a shows the bearing 200 in a flat state and FIG. 2b shows it in a bent, ready to use, configuration.

The bearing 200 comprises a generally planar section of material which has been shaped and sized to ensure a reliable and accurate fit between adjacent tube sections. The bearing 200 may be composed of a nylon material or a PTFE material as required. It is found that a PTFE bearing has advantages in that if it is kept under pressure it ‘flows’ so that over time if the fit is too tight, it will naturally reduce its thickness, making for a better performing bearing. Other bearing materials can also be used, such as a range of different plastics materials and non-ferrous materials, such as bronze.

In the embodiment shown which features a square cross section tubular leg arrangement, the bearing 200 is arranged to be scored at a central position 210 such that it may be folded around a corner of the tubular section. The bearing 200 is further provided with one or more locating apertures 220 which are arranged to align with corresponding projections on the tubular sections.

Even though there can be a degree of variation between different batches of tubular leg sections, individual samples from within a given batch tend to be very consistent. This allows a measurement to be made of the internal/external diameters of adjacent leg portions and suitable bearings 200 can be manufactured to a given size which can then be used in all legs 1 from that same batch. The thickness of the bearing can be set by selecting from a range of defined thickness ‘blanks’ or else the desired thickness can be achieved by machining (e.g planing) a suitable piece of material.

The bearings are arranged to be fitted at one or more positions to each tubular section. This can be seen more clearly from FIGS. 3. Here, the upper section 110 is provided with four bearings 200 positioned around the lower external portion of this section which is then inserted into the central section 120. The central section 120 is also provided with four bearings, but provided at an internal surface of its upper end. In this way, fluid movement of the upper section 110 within the central section 120 can be maintained.

The same arrangement is used between the central section 120 and the lower section 130.

By providing bearings as shown, smooth movement can be provided between adjacent sections when the leg is lengthened or shortened, and the stability of the leg is improved.

FIG. 3 also shows the triple screw actuator 300 which is provided to lock each leg to a given length. The triple screw actuator 300 comprises, in this configuration, three sections. The outer section 310 is provided with an internal thread into which is fitted the central section 320 which again has an internal thread to which is fitted the lower section 330 which is a threaded bar. The triple screw actuator 300 is attached at its upper surface to the fixing plate 100. The lower end of the triple screw actuator 300 is attached to the footplate 140.

In order to adjust the height of a given leg, a tool such as a hexagonal socket or screwdriver is inserted through opening 115 to turn a bevel gear, which forms part of the upper section 310 of the triple screw actuator 300. The bevel gear turns one of the screws which makes up the triple screw actuator, thereby causing the sections of the leg 1 to lengthen or shorten as required.

As an alternative to the triple screw actuator 300 shown, the actuator could, depending on the particular application, be a single, double or other multiple screw, a spring or a gas spring actuator.

The particular embodiment shown and described here utilises three separate sections 110, 120 130 for each leg. By use of three sections in this way, the range of height adjustment which can be achieved is suitable to allow a height adjustment from EN1729 “Size Mark 2 Sitting” (suitable for a five year old child to sit at) to EN1729 “Size Mark 6 Standing” (suitable for a male adult to stand at). Such a range of variability would be very difficult or impossible to provide using any other form of height adjustable leg. As such, depending on the particular application which is required, a height adjustable leg can be configured with fewer than three sections or more than three sections, depending upon the exact requirements.

An item of furniture may be arranged such that a single adjustment can alter the height of multiple legs. For instance, it has been described how the height of a single leg can be adjusted by use of a bevel gear arrangement, and it is possible to interconnect two or more legs using such an arrangement so that all legs move in sympathy. Such an arrangement can if necessary, be motorised to allow automation of the height-adjustment process.

As can be seen from the foregoing description and accompanying drawings, it is clear that embodiments of the invention offer reliable and economic means for achieving a wide range of heights in height adjustable furniture. Furniture constructed using such embodiments will allow the user to alter the height in a predictable and reliable fashion across a wide range of different heights, whilst still being sturdy and strong.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A height adjustable leg for use with furniture, comprising:
first and second tubular sections arranged to telescopically couple;
an actuator arranged internally to the first and second sections to maintain a selected height;
a bearing arranged between the first and second sections to allow smooth relative movement therebetween and to accommodate manufacturing tolerances.

2. The leg of claim 1 further comprising a third section, arranged to telescopically couple with the second section and wherein the first section is terminated in a fixing plate for attachment to an underside of a work surface and the third section is terminated in a footplate for resting on a floor surface.

3. The leg of claim 1 wherein the tubular sections comprise steel.

4. The leg of claim 1 wherein the tubular sections have one of square, rectangular or circular cross-sections.

5. The leg of claim 1 wherein the bearing is selected from one of a range of possible thicknesses, depending on the measured internal and external diameters of respective tubular sections, such internal and external diameters being substantially constant for a given batch of tubular sections.

6. The leg of claim 1 wherein the actuator comprises one of a multi-screw actuator, a spring or a gas-spring.

7. The leg of claim 1 wherein the bearing is of planar construction, comprising at least one alignment apertures for co-operation with at least one alignment projections located on one of the tubular sections.

8. The leg of claim 1 wherein the bearing comprises at least one of nylon and PTFE.

9. An item of furniture comprising a leg according to claim 1.

10. (canceled)
